(19) United States
(12) Patent Application Publication
(10) Pub. No.: US 2007/0054968 A1
(43) Pub. Date: Mar. 8, 2007

(54) Environmentally friendly defoamer

(75) Inventor: William Chrys Scoggins, Celle (DE)

Correspondence Address: JONES & SMITH, LLP, THE RIVIANA BUILDING, 2777 ALLEN PARKWAY, SUITE 800, HOUSTON, TX, 77019-2141, US

(73) Assignee: BJ Services Company

(21) Appl. No.: 11/210,179

(22) Filed: Aug. 23, 2005

(51) Int. Cl. B01D 19/04; C09K 8/00; E21B 43/00

(52) U.S. Cl. 516/125; 507/235

(57) ABSTRACT

A defoamer containing an alkanol, lecithin and water has particular applicability in the treatment of hydraulic cements used in hydrocarbon-bearing formations and in the cleaning of pipes and pipe lines. The defoamer is composed of environmentally friendly components.

### FIELD OF THE INVENTION

The invention relates to an environmentally friendly defoamer having particular applicability for use in offshore oilfields.

### BACKGROUND OF THE INVENTION

Defoamers are widely used in the treatment of hydrocarbon-bearing formations. For instance, defoamers are often used in hydraulic cements in the cementing of pipes or casings within a wellbore. In such applications, defoamers are typically added to the mixing water to ensure uniform mixing and to minimize air entrapment and foaming caused during mixing.

In addition to cementing, defoamers are typically used in stimulation treatments, such as fracturing, as well as in completion fluids where they may be used in spacing, perforating, gravel packing, installing casing, underreaming and milling. Further, defoamers are often used in drilling fluids, completion fluids and workover fluids.

There is an increasing need for the development of treatment fluids which contain environmentally friendly components. Decisions made by the Convention for the Protection of the Marine Environment of the North-East Atlantic (OSPAR Convention) have had a large effect on the establishment of less hazardous substances for discharge in offshore operations. For instance, some chemicals have been identified as Pose Little or No Risk to the Environment (PLONOR). Inclusion of chemicals on the PLONOR list exempts testing requirements of such substances under the OSPAR mandates. In the United States, similar demands are being made on the industry to employ substances which are environmentally friendly.

### SUMMARY OF THE INVENTION

The defoamer of the invention contains an alkanol, lecithin and water. Suitable alkanols include methanol, ethanol (including denatured ethanol), propanol, isopropanol, butanol and monoethylene glycol. Suitable lecithins include soya lecithin. The defoamer contains between from about 50 to about 85 weight percent alkanol and between from about 5 to about 15 weight percent of lecithin. The balance is water.

The defoamer has particular applicability in cementing, stimulation and in the cleaning of pipes. In particular, the defoamer is used to reduce and/or prevent the entrainment of air in fresh water and brine fluids.

### BRIEF DESCRIPTION OF THE DRAWINGS

FIG. 1 illustrates the effect of defoamers, in accordance with the invention, on surface foam as set forth in Examples 1 and 2.

### DETAILED DESCRIPTION OF THE PREFERRED EMBODIMENTS

The defoamer of the invention may be composed of only environmentally friendly chemicals, such as those listed on the PLONOR list.

The defoamer contains an alkanol, lecithin and water. The alkanol preferably comprises selected from the group consisting of methanol, ethanol (including denatured ethanol), propanol, isopropanol, butanol and monoethylene glycol. In a preferred embodiment, the butanol is 1-butanol or 2-butanol, most preferred I-butanol.

In a preferred embodiment, the lecithin may be obtained from soybeans with soya lecithin being preferred. The lecithin may be natural or synthetic lecithin, including soya lecithin. Preferred phospholipids and lecithin include phosphatidylcholine, phosphatidylethanolamine, and phosphatidylinositol.

Typically, the defoamer may contain between from about 50 to about 85, preferably between from about 70 to about 80, weight percent of alkanol and between from about 5 to about 15, preferably between from about 6 to about 10, weight percent of lecithin; the balance being water.

The defoamer has particular applicability in enhancing the productivity of a hydrocarbon-bearing formation. In a preferred embodiment, the defoamer may be used in such applications as cementing and stimulation, including fracturing. Further, the defoamer of the invention may be used in the cleaning of pipes and pipe lines. Suitable pipes and pipe lines include dry gas pipe and processed fluid pipe lines.

The defoamer may be admixed with other well treatment chemicals and may be added on the fly or in conjunction with other systems, such as a carrier fluid. Typically, the defoamer is used to reduce and/or prevent the entrainment of air in fresh water and brine fluids. It usually is applied directly added slowly to the fluid while mixing. Alternatively, especially in cases of severe foam, it may be sprayed directly on the foam surface. In a typical application, 5 gallons of defoamer per 250 bbls of fluid is employed.

The following examples will illustrate the practice of the present invention in its preferred embodiments. All parts are given in terms of weight units except as may otherwise be indicated. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

### EXAMPLES

### Example 1

A defoamer was prepared by mixing, at room temperature, components to render the following composition: 2-butanol (75.0% by weight), soya lecithin (8.33% by weight) and water (16.67% by weight).

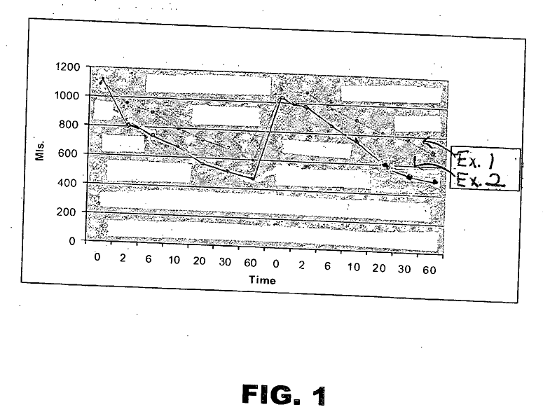

A seawater based mixwater containing 305.6 g (56.5%) sea water, 196.9 g (36.4%) of an aqueous suspension of silica particles having an average size of 0.8 microns, 31.5 ml (6.0%) of a non-ionic polymer/surfactant liquid fluid loss additive (FL-45 LN) and 5 ml (1.1%) of a polymerized naphthalene sulfonate were mixed in a Waring blender These are all products of BJ Services Company. The mixwater was prepared in accordance with API Spec. 10 for two hours. The foamed mixwater was then poured into a 1 L measuring cylinder and the volume was recorded. 1.6 g (0.30%) of the defoamer was then added on top of the cylinder and the volume was recorded for 1 hour. This is indicative of the defoaming effect on the surface foam as illustrated on the left side of the graph of FIG. 1. After one hour, the sample was poured back into a Waring blender and mixed at extreme conditions (12,000 rpm) for 35 seconds. The sample was then poured back into the measuring cylinder and the volume was recorded for one more hour. The results are illustrated by the right side of the graph of FIG. 1.

### Example 2

Example 1 was repeated except 1-butanol (75.0% by weight) was substituted for the 2-butanol. The results are illustrated in FIG. 1

As set forth in FIG. 1, the defoamer of Example 2 exhibits slightly better effects on surface foam than the defoamer of Example 1. When the mixwater was stirred back up to 12,000 rpm, a small improvement was further noted. The defoamer of Example 2 brings the foam level down a little faster than the defoamer of Example 1.

### Example 3

The effects on retardation of the defoamers of Examples 1 and 2 on cementitious slurry were examined. The cementitious slurry was prepared by admixing 800 g of class G Portland cement, the defoamer (0.2% by weight of cement, BWOC), a liquid retarder from BJ Services Company (0.6% BWOC) and water (43.17% BWOC). The temperature differential was 44/590 C BHCT/BHST, where BHCT is bottom hole circulating temperature and BHST is bottom hole static temperature. The slurry density was 1.31 g/cc. The slurry was tested with five times the normal loading of defoamer.

Thickening times, wherein BC is Bearden Consistency and BHCT is Bottom Hole Circulating Temperature, are set forth in Table I:

TABLE I

| | Ex. 1 | Ex. 2 | Ex. 1 | Ex. 2 |
|---|---|---|---|---|
| Thickening Time | Defoamer, | Defoamer, | Defoamer, | Defoamer, |
| (Hrs:Mins) | 0.2 LHK | 0.2 LHK | 1.0 LHK | 1.0 LHK |
| 30 BC @ BHCT | 4:26 | 3:53 | 6:00 | 5:26 |
| 70 BC @ BHCT | 5:01 | 4:38 | 6:40 | 5:58 |
| 100 BC @ BHCT | 5:19 | 4:51 | 6:55 | 6:14 |

LHK = liters per hundred kilos of cement

From the foregoing, it will be observed that numerous variations and modifications may be effected without departing from the true spirit and scope of the novel concepts of the invention.

What is claimed is:

1. A defoamer comprising:
(a.) an alkanol selected from the group consisting of methanol, ethanol, propanol, isopropanol, butanol and monoethylene glycol;
(b.) lecithin; and
(c.) water.

2. The defoamer of claim 1, wherein the lecithin is soya lecithin.

3. The method of claim 1, wherein the alkanol is selected from the group consisting of 1-butanol and 2-butanol.

4. The defoamer of claim 3, wherein the alkanol is 1-butanol.

5. The defoamer of claim 1, wherein the defoamer comprises between from about 50 to about 85 weight percent of alkanol.

6. The defoamer of claim 5, wherein the defoamer comprises between from about 70 to about 80 weight percent of alkanol.

7. The defoamer of claim 6, wherein the defoamer comprises about 75 weight percent of alkanol.

8. The defoamer of claim 6, wherein the alkanol is selected from the group consisting of 1-butanol and 2-butanol.

9. The defoamer of claim 8, wherein the alkanol is 1-butanol.

10. The defoamer of claim 2, wherein the alkanol is selected from the group consisting of 1-butanol and 2-butanol.

11. The defoamer of claim 1, wherein the defoamer comprises between from about 5 to about 15 weight percent of lecithin.

12. The defoamer of claim 11, wherein the defoamer comprises between from about 6 to about I0 weight percent of lecithin.

13. A defoamer comprising:
(a.) between from about 50 to about 85 weight percent of an alkanol selected from the group consisting of methanol, ethanol, propanol and butanol;
(b.) between from about 5 to about 15 weight percent of lecithin; and
(c.) water.

14. The defoamer of claim 13, wherein the lecithin is soya lecithin.

15. The defoamer of claim 13, wherein the alkanol is selected from the group consisting of 1-butanol and 2-butanol.

16. The defoamer of claim 13, wherein the alkanol is butanol and the lecithin is soya lecithin.

17. The defoamer of claim 16, wherein the butanol is 1-butanol.

18. The defoamer of claim 13, wherein the defoamer comprises between from about 70 to about 80 weight percent of alkanol.

19. A method of treating an oil or gas producing well which comprises introducing into the well the defoamer of claim 1.

20. A method of treating an oil or gas producing well which comprises introducing into the well the defoamer of claim 13.
